(19) United States
(12) Patent Application Publication
(10) Pub. No.: US 2014/0177135 A1
(43) Pub. Date: Jun. 26, 2014

(54) ELECTROCHEMICAL DEVICE

(71) Applicant: TAIYO YUDEN CO., LTD., TOKYO (JP)

(72) Inventors: Kyotaro MANO, Takasaki-shi (JP); Naoto HAGIWARA, Takasaki-shi (JP); Katsuei ISHIDA, Takasaki-shi (JP)

(73) Assignee: TAIYO YUDEN CO., LTD., TOKYO (JP)

(21) Appl. No.: 14/061,504

(22) Filed: Oct. 23, 2013

(30) Foreign Application Priority Data
Oct. 30, 2012 (JP) 2012-238461

(51) Int. Cl. H01G 11/80; H01G 11/78

(52) U.S. Cl. CPC H01G 11/80; H01G 11/78
USPC 361/502

(57) ABSTRACT

An electrochemical device that can ensure long-term reliability is equipped with a solution chamber and an electric storage element. The solution chamber houses electrolytic solution and has a first face and a second face opposing the first face. The electric storage element is positioned in the solution chamber and has a first electrode provided on the first face and a second electrode provided on the first face away from the first electrode. This way, an electrochemical device that can ensure long-term reliability can be provided.

### FIELD OF THE INVENTION

The present invention relates to an electrochemical device having a built-in electric storage element that can be charged and discharged.

### DESCRIPTION OF THE RELATED ART

Patent Literature 1 discloses a general electrochemical device. This electrochemical device contains an electric storage element and the electric storage element has a positive-electrode active material electrode, negative-electrode active material electrode, and separator placed in between. The electric storage element is housed, together with electrolytic solution, in a concaved container made of ceramic. The container housing the electric storage element is sealed by means of a lid made of a metal material via a seal ring.

With this electrochemical device, the electric storage element is sandwiched between the bottom face of the container and the inner face of the lid. To be more specific, the positive-electrode active material electrode is joined via a current collector to the bottom face of the container, while the negative-electrode active material electrode is joined to the lid. Because of this constitution, this electrochemical device permits charging and discharging of the electric storage device via specified wirings by using the current collector of the container as the positive electrode and the lid as the negative electrode.

It is known that, with such electrochemical device, generally the current collector on the positive-electrode active material electrode side corrodes more easily than the lid or seal ring on the negative electrode side. Patent Literature 2 discloses covering a current collector with aluminum or other valve metal to prevent the current collector from corroding.

### BACKGROUND ART LITERATURES

[Patent Literature 1] Japanese Patent Laid-open No. 2001-216952
[Patent Literature 2] Japanese Patent Laid-open No. 2011-228263

### SUMMARY

As the electrochemical device is used for a long time, however, the metal material forming the lid and seal ring that constitute the negative electrode may elute to the electrolytic solution. As a result, the metal that has eluted to the electrolytic solution may deposit onto the electric storage element and cause short-circuiting in the electrochemical device. Additionally, corrosion of the lid may prevent good contact between the lid and negative-electrode active material electrode, thereby causing the internal resistance of the electrochemical device to rise or device capacity to drop.

In light of the aforementioned situations, an object of the present invention is to provide an electrochemical device whose long-term reliability can be ensured.

To achieve the aforementioned object, the electrochemical device according to an embodiment of the present invention is equipped with a solution chamber and electric storage element.

The solution chamber houses electrolytic solution and has a first face and a second face opposing the first face.

The electric storage element is positioned in the solution chamber and has a first electrode provided on the first face and a second electrode provided on the first face away from the first electrode.

The electrochemical device according to another embodiment of the present invention is equipped with multiple electrochemical units, each having a solution chamber and electric storage element, as well as connection wirings that connect the multiple electrochemical units.

The solution chamber of the electrochemical unit houses electrolytic solution and has a first face and a second face opposing the first face.

The electric storage element of the electrochemical unit is positioned in the solution chamber and has a first electrode provided on the first face and a second electrode provided on the first face away from the first electrode.

An electrochemical device whose long-term reliability can be ensured is provided.

Any discussion of problems and solutions involved in the related art has been included in this disclosure solely for the purposes of providing a context for the present invention, and should not be taken as an admission that any or all of the discussion were known at the time the invention was made.

For purposes of summarizing aspects of the invention and the advantages achieved over the related art, certain objects and advantages of the invention are described in this disclosure. Of course, it is to be understood that not necessarily all such objects or advantages may be achieved in accordance with any particular embodiment of the invention.

Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description which follows.

### DESCRIPTION OF THE SYMBOLS

10—Electrochemical device
11—Base material
12—Lid
13—Seal ring
14, 15—Wiring
16, 17—Active material electrode
18, 19—Conductive adhesion layer
c—Container
d—Electric storage element
R—Solution chamber

### BRIEF DESCRIPTION OF THE DRAWINGS

These and other features of this invention will now be described with reference to the drawings of preferred embodiments which are intended to illustrate and not to limit the invention. The drawings are greatly simplified for illustrative purposes and are not necessarily to scale.

FIG. 1 is a perspective view showing the overall constitution of the electrochemical device according to the first embodiment of the present invention.

FIG. 2 is a schematic section view of the electrochemical device shown in FIG. 1, cut along line A-A′.

FIG. 3 is a schematic section view of a comparative example of the electrochemical device shown in FIG. 2.

FIG. 4 is a schematic section view of a modified example of the electrochemical device shown in FIG. 2.

FIG. 5 is a schematic section view of a modified example of the electrochemical device shown in FIG. 2.

FIG. 6 is a schematic section view of a modified example of the electrochemical device shown in FIG. 2.

FIG. 7 is a schematic section view of a modified example of the electrochemical device shown in FIG. 2.

FIG. 8 is a drawing showing a variation of the active material electrode shape of the electrochemical device shown in FIG. 2.

FIG. 9 is a schematic section view of the electrochemical device according to the second embodiment of the present invention.

FIG. 10 is a schematic section view of a comparative example of the electrochemical device shown in FIG. 9.

FIG. 11 is a schematic section view of a comparative example of the electrochemical device shown in FIG. 9.

### DETAILED DESCRIPTION OF EMBODIMENTS

To achieve the aforementioned object, the electrochemical device according to an embodiment of the present invention is equipped with a solution chamber and electric storage element.

The solution chamber houses electrolytic solution and has a first face and a second face opposing the first face.

The electric storage element is positioned in the solution chamber and has a first electrode provided on the first face and a second electrode provided on the first face away from the first electrode.

According to this electrochemical device, the metal material does not elute from the second face and therefore short-circuiting, rise in internal resistance, or drop in capacity can be prevented over a long time.

The second face may be away from the electric storage element.

Because of this constitution, the pair of electrodes will not short-circuit even when the second face is formed by a metal material or other conductive material.

The electrochemical device may be further equipped with a base material having the first face and a lid having the second face.

With this electrochemical device, the electric storage element and electrolytic solution can be sealed with greater ease by combining the base material and lid.

The electrochemical device may be further equipped with a seal positioned between the base material and lid and having the second face.

With this electrochemical device, close contact between the base material and lid can be ensured, resulting in high reliability.

The electrochemical device may be further equipped with a pair of external electrode terminals that are exposed on the face opposite the first face of the base material and led out from the first electrode and second electrode, respectively.

This electrochemical device can be mounted easily in electronic equipment, etc., while achieving the aforementioned effects.

The electrochemical device may be further equipped with conductive adhesion layers functioning as current collector films, positioned between the first electrode and first face and between the second electrode and first face, respectively.

According to this electrochemical device, fewer parts are required and the manufacturing cost decreases as a result because the conductive adhesion layers cause the first electrode and second electrode to adhere to the first face, while also functioning as current collector films.

The electrochemical device according to another embodiment of the present invention is equipped with multiple electrochemical units, each having a solution chamber and electric storage element, as well as connection wirings that connect the multiple electrochemical units.

The solution chamber of the electrochemical unit houses electrolytic solution and has a first face and a second face opposing the first face.

The electric storage element of the electrochemical unit is positioned in the solution chamber and has a first electrode provided on the first face and a second electrode provided on the first face away from the first electrode.

According to this electrochemical device, any number of electrochemical units can be combined freely via the connection wirings and therefore the capacity can be increased or charge/discharge voltage raised with ease.

The electrochemical device may be further equipped with a base material having a first face and common to the multiple electrochemical units.

According to this electrochemical device, fewer parts are required and the manufacturing cost decreases as a result because the multiple electrochemical units can be held using the same member. Also according to this electrochemical device, the multiple electrochemical units are provided on the common base material and therefore the device can be handled with greater ease when mounted in electronic equipment, etc.

The electrochemical device may be further equipped with a lid having a second face and common to the multiple electrochemical units.

According to this electrochemical device, fewer parts are required and the manufacturing cost decreases as a result because the multiple electrochemical units can be sealed using the same member.

With this electrochemical device, all of the electric storage elements may be connected in series via the connection wirings.

According to this electrochemical device, the charge voltage can be raised with ease as a single device.

Embodiments of the present invention are explained below by referring to the drawings.

### First Embodiment

### Overall Constitution of Electrochemical Device 10

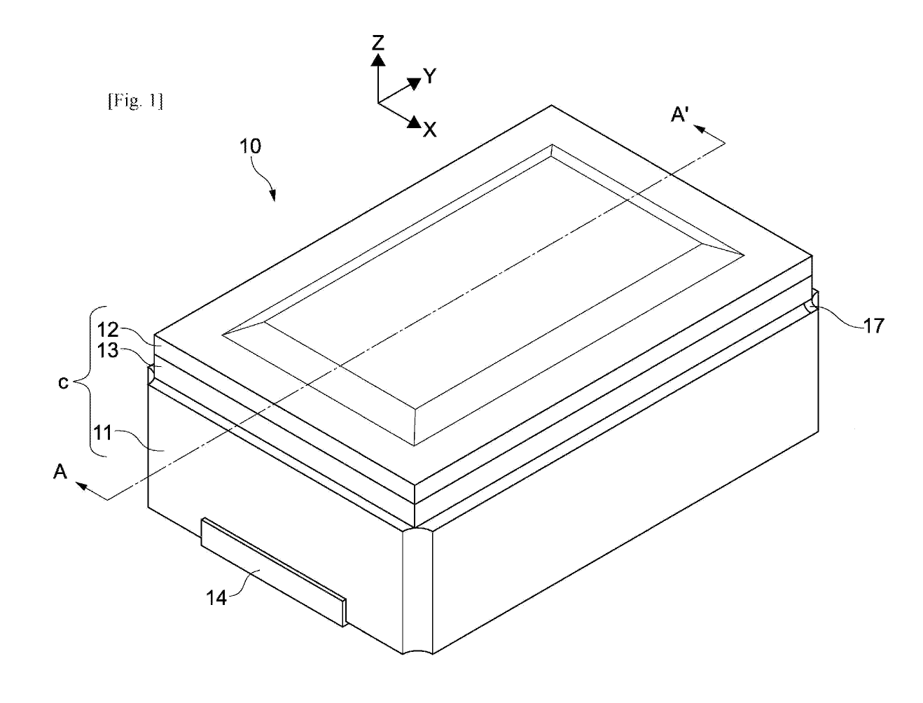

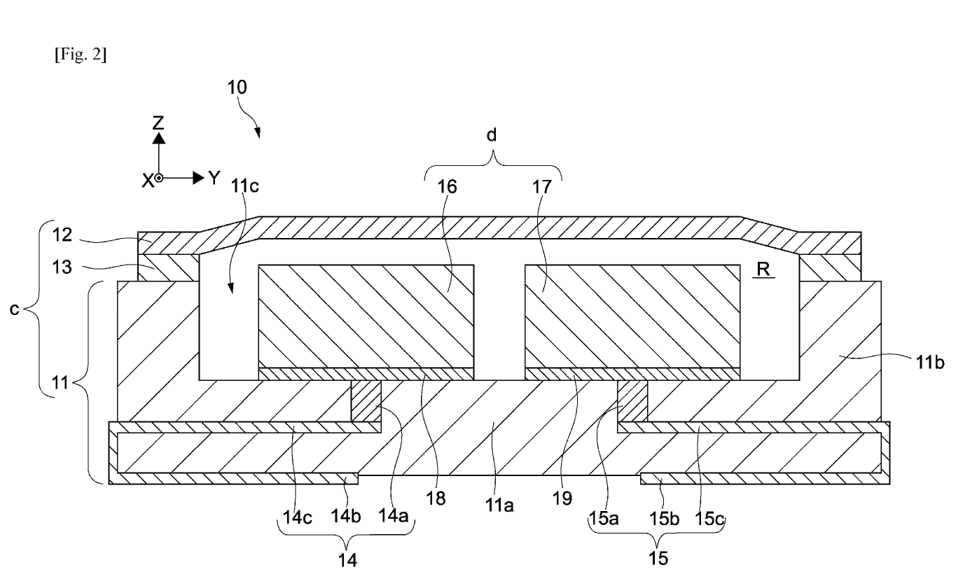

FIG. 1 is a perspective view showing the overall constitution of an electrochemical device 10 according to a first embodiment of the present invention. FIG. 2 is a schematic section view of the electrochemical device 10 shown in FIG. 1, cut along line A-A′. It should be noted that each drawing shows the X-axis, Y-axis and Z-axis that are crossing with one another at right angles. The X-axis, Y-axis and Z-axis are the same in all drawings.

The electrochemical device 10 can adopt various shapes. As one example, an electrochemical device 10 shaped as a rectangular solid whose width dimension along the X-axis is 2.5 mm, length dimension along the Y-axis is 3.2 mm, and height dimension along the Z-axis is 0.95 mm, is explained in this embodiment.

The electrochemical device 10 has: a container c comprising a base material 11, lid 12, and seal ring 13; and an electric storage element d sealed in the container c together with electrolytic solution and comprising a pair of active material electrodes 16, 17. The pair of active material electrodes 16, 17 are such that one functions as a positive-electrode active material electrode and the other, as a negative-electrode active material electrode.

The electrochemical device 10 is constituted as a PAS (polyacenic semiconductor) capacitor, electrical double-layer capacitor, or secondary battery, for example. Also with the electrochemical device 10, one of the active material electrodes 16, 17 may be constituted as a lithium ion capacitor being a negative-electrode active material electrode containing lithium.

The electrochemical device 10 is used, for example, as a backup power supply for electronic equipment, etc. In this case, the electrochemical device 10 is constituted as a surface-mounted component that can be mounted onto a circuit board of electronic equipment by means of reflow soldering or other method. For this reason, the electrochemical device 10 has external electrode terminals 14b, 15b provided on it, which are connected to the active material electrodes 16, 17, respectively, and exposed to the bottom face in the Z-axis direction.

### Container c

The container c has a box-shaped base material 11 whose top in the Z-axis direction is open, lid 12 that seals off the base material 11, and seal ring 13 that joins the base material 11 and lid 12.

### Base Material 11

The base material 11 of the container c is formed as a whole roughly in a rectangular solid shape using ceramic or other insulation material. The base material 11 has a rectangular bottom wall 11a extending in the X-axis direction and Y-axis direction, respectively, and a periphery wall 11b extending planarly upward in the Z-axis direction from the four sides of the bottom wall 11a. Also, the base material 11 has a concaved part 11c that is surrounded by the top face of the bottom wall 11a in the Z-axis direction and by the inner face of the periphery wall 11b, and opens upward in the Z-axis direction.

The base material 11 is produced by laminating multiple ceramic sheets in the Z-axis direction and then sintering the laminated sheets. The bottom wall 11a is formed by laminating multiple ceramic sheets. The periphery wall 11b is formed by laminating one or more ceramic sheets, each having an opening, on the ceramic sheets forming the bottom wall 11a, for example. A metal paste that will become the wirings described later may be applied to the ceramic sheets forming the bottom wall 11a before sintering.

### Lid 12

The lid 12 of the container c is constituted by a sheet material of roughly rectangular shape. The lid 12 has a shape whose periphery along the four sides is stepped down from the center toward the base material 11. Alternatively, the lid 12 may have a shape where the center is stepped down from the periphery toward the base material 11, or a flat shape where the periphery and center are flush with each other.

The lid 12 is formed by Kovar (Fe (iron)-Ni (nickel)-Co (cobalt)) alloy, for example. With the electrochemical device 10 according to this embodiment, the lid 12 need not have electrode function and therefore the material for forming the lid 12 is not at all limited to various metal materials and other conductive materials.

Accordingly, various ceramics, organic materials, and other insulation materials or semiconductor materials or the like can be adopted for the material for forming the lid 12. If an organic material is used to form the lid 12, a reaction suppression layer that does not react easily with the electrolytic solution can be formed on the inner face of the lid 12, as deemed appropriate. Note that, since the lid 12 is joined to the base material 11, desirably it is formed by a material whose linear expansion coefficient is close to that of the material forming the base material 11 or material having flexibility to some extent.

The lid 12, if formed by a conductive material, must be away from the active material electrodes 16, 17 so as not to short-circuit the active material electrodes 16, 17. On the other hand, the lid 12, if formed by an insulation material, may be in contact with the active material electrodes 16, 17 because it will not short-circuit the active material electrodes 16, 17.

### Seal Ring 13

The seal ring 13 of the container c is positioned between the base material 11 and lid 12 and constituted as a seal that maintains close contact with both the base material 11 and lid 12. Accordingly, the seal ring 13 is ring-shaped and positioned in a manner surrounding the concaved part 11c of the base material 11 along the top edge, in the Z-axis direction, of the periphery wall 11b of the base material 11.

The seal ring 13 is formed by Kovar alloy just as the lid 12 is. However, the seal ring 13 needs only to be formed by a material that maintains close contact with both the base material 11 and lid 12. As is the case with the lid 12, therefore, a wide range of insulation materials and semiconductor materials can be adopted, among others, for the material forming the seal ring 13. In addition, it is desirable that the seal ring 13 is also formed by a material whose linear expansion coefficient is close to that of the material forming the base material 11, where constituting it with a material of the same type as or identical to the material of the lid 12 is preferred.

If the base material 11 and lid 12 can maintain close contact directly with each other, then the seal ring 13 is not necessary.

### Solution Chamber R

With the electrochemical device 10, the pair of active material electrodes 16, 17 constituting the electric storage element d are provided, via conductive adhesion layers 18, 19, on the bottom face (first face) of the concaved part 11c, and after the electrolytic solution is filled into the concaved part 11c, the base material 11, lid 12, and seal ring 13 are joined together. This way, a liquid-tight solution chamber R surrounded by the base material 11, lid 12, and seal ring 13 is formed.

In other words, the solution chamber R is formed by being surrounded by the first face (bottom face of the concaved part 11c) to which the active material electrodes 16, 17 are joined, and by the second face (side face of the concaved part 11c, inner face of the lid 12 and inner face of the seal ring) away from the active material electrodes 16, 17.

The base material 11, lid 12, and seal ring 13 are joined together by the welding method. To be specific, the lid 12 is joined to the base material 111 via the seal ring 13 by the laser welding method. Needless to say, any of various joining technologies other than the welding method may be adopted to join the base material 11, lid 12 and seal ring 13. Additionally, the constitution according to which to form the solution chamber R may not be one based on a combination of the lid 12 and seal ring 13.

### Wiring Structure of Base Material 11

The base material 11 has a first wiring 14 connected to the active material electrode 16 and a second wiring 15 connected to the active material electrode 17. The wirings 14, 15 have via holes 14a, 15a, external electrode terminals 14b, 15b, and inter-layer wirings 14c, 15c, all embedded in the bottom face of the concaved part 11c.

The via holes 14a, 15a are provided in the Z-axis direction through the ceramic sheet forming the bottom face of the concaved part 11c, among the ceramic sheets constituting the bottom wall 11a. The via holes 14a, 15a are exposed on the bottom face of the concaved part 11c and adjoining the conductive adhesion layers 18, 19, respectively. This way, the via holes 14a, 15a are connected to the active material electrodes 16, 17 via the conductive adhesion layers 18, 19.

The external electrode terminals 14b, 15b are provided on both ends of the base material 11 in the Y-axis direction, respectively. To be specific, the external electrode terminals 14b, 15b are provided integrally on the outer face of the base material 11 over the section from the bottom wall 11a to the side wall 11b.

The inter-layer wirings 14c, 15c are formed between the multiple layers of ceramic sheets constituting the bottom wall 11a. The inter-layer wirings 14c, 15c connect the via holes 14a, 15a and external electrode terminals 14b, 15b, respectively.

The via holes 14a, 15a, external electrode terminals 14b, 15b and inter-layer wirings 14c, 15c are formed by various metals or other conductive materials. One such conductive material is tungsten (W), for example. In addition, the via holes 14a, 15a, external electrode terminals 14b, 15b and inter-layer wirings 14c, 15c may also be formed by a complex material constituted by multiple metal materials, such as a laminate film constituted by tungsten covered with nickel or gold.

The via holes 14a, 15a may be provided only at one location or at multiple locations, respectively. If the via holes 14a, 15a are provided at multiple locations, the inter-layer wirings 14c, 15c connecting the via holes 14a, 15a to the external electrode terminals 14b, 15b may be provided separately for each of via holes 14a, 15a or used commonly for all via holes 14a, 15a.

The wiring structure of the base material 11 is not at all limited to the foregoing, so long as the external electrode terminals 14b, 15b are led out from the active material electrodes 16, 17. In particular, the electrochemical device 10 can be used as a surface-mounted component so long as the external electrode terminals 14b, 15b are exposed on the bottom face, in the Z-axis direction, of the bottom wall 11a of the base material 11, respectively.

As mentioned above, the electrochemical device 10 has its wirings 14, 15 led out to the external electrode terminals 14b, 15b from the active material electrodes 17, 18 constituting the electric storage element d in the base material 11, and therefore the electric storage element d can be charged/discharged using the external electrode terminals 14b, 15b. Note that, while current collector films corresponding to the active material electrodes 16, 17 are not provided in this embodiment, the conductive adhesion layers 18, 19 function as current collector films while also joining the active material electrodes 16, 17 to the base material 11.

### Electric Storage Element d

As described above, the active material electrodes 16, 17 provided on the bottom face of the concaved part 11c of the base material 11 form a pair to constitute the electric storage element d. The pair of active material electrodes 16, 17 of the electric storage element d according to this embodiment are both connected to the base material 11 and away from the lid 12 or seal ring 13. The active material electrode 16 is connected to the via hole 14a via the conductive adhesion layer 18, while the active material electrode 17 is connected to the via hole 15a via the conductive adhesion layer 19.

The active material electrodes 16, 17 are each constituted by a sheet containing active material. The active material may be active carbon or PAS (polyacenic semiconductor), for example. At the active material electrodes 16 or 17, a capacitor is formed by electrical double layers to generate a specified capacitance [F]. The capacitance of the active material electrode 16 or 17 is specified by the product of the amount of active material [g], surface area of active material [m²/g], and specific volume of active material [F/m²].

To be specific, the active material electrodes 16, 17 are each formed by mixing active material grains (such as active carbon grains), conductive auxiliary (such as Ketjen Black), and binder (such as PTFE (polytetrafluoroethylene)), and rolling the mixture to form a sheet, and then cutting the sheet to a rectangular shape. Both the active material electrodes 16, 17 are formed to a thickness of 0.2 mm, for example. However, the active material electrodes 16, 17 can have any arbitrarily determined thickness and the thickness of the active material electrode 16 may be different from that of the active material electrode 17.

The electrolytic solution to be sealed in the solution chamber R of the container c together with the electric storage element d is determined as deemed appropriate. For the electrolytic solution, a quaternary ammonium salt solution containing BF₄⁻ (boron tetrafluoride ion), or specifically 5-azoniaspiro[4.4]nonane-BF₄ or ethyl methyl imidazolium nonane-BF₄ solution, can be used, for example.

### Operations and Effects of Electrochemical Device 10

The operations and effects of the electrochemical device 10 according to this embodiment are explained below based on comparison against an electrochemical device 110 according to a comparative example.

### Rough Constitution of Electrochemical Device 110 According to Comparative Example

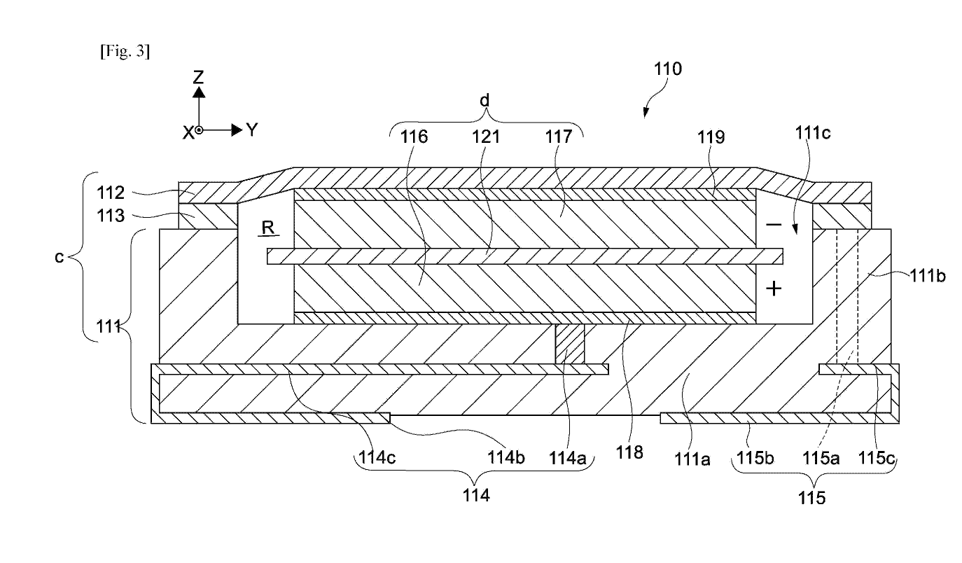

FIG. 3 is a schematic section view of the electrochemical device 110 according to a comparative example of this embodiment. This electrochemical device 110 also has the container c and electric storage element d, and the electric storage element d is sealed in the solution chamber R of the container c together with electrolytic solution. The container c includes a base material 111, lid 112, and seal ring 113. The electric storage element d has a positive-electrode active material electrode 116, negative-electrode active material electrode 117, and separator 121 positioned in between.

The positive-electrode active material electrode 116 is joined to the bottom face of a concaved part 111c of the base material 111 via a conductive adhesion layer 118, while the negative-electrode active material electrode 117 is joined to the inner face of the lid 112 via a conductive adhesion layer 119. In other words, the electric storage element d of the electrochemical device 110 is sandwiched between the base material 111 and lid 112. According to this constitution, with the electrochemical device 110 the conductive adhesion layer 118 adjoining the positive-electrode active material electrode 116 functions as a positive electrode, while the lid 112 and seal ring 113 function as a negative electrode.

The base material 111 has positive electrode wiring 114 and negative electrode wiring 115 provided on it. The positive electrode wiring 114 includes a via hole 114a, external electrode terminal 114b, and inter-layer wiring 114c, while the negative electrode wiring 115 includes a via hole 115a, external electrode terminal 115b, and inter-layer wiring 115c. The external electrode terminal 114a connects to the conductive adhesion layer 118 adjoining the positive-electrode active material electrode 116 via the via hole 114a and inter-layer wiring 114c, while the external electrode terminal 115a connects to seal ring 113 via the via hole 115a and inter-layer wiring 115c.

According to the above constitution, the electrochemical device 110 permits charging/discharging of the electric storage element d using the external electrode terminals 114b, 115b.

### Comparison of this Embodiment and Comparative Example

With the electrochemical device 110 according to the comparative example, where the lid 112 and seal ring 113 function as a negative electrode, the metal material forming the lid 112 and seal ring 113 may elute to the electrolytic solution and cause short-circuiting, rise in internal resistance, or drop in capacity.

With the electrochemical device 10 according to this embodiment, on the other hand, the lid 12 and seal ring 13 do not function as an electrode and therefore the material forming the lid 12 and seal ring 13 does not elute to the electrolytic solution. Accordingly, the electrochemical device 10 can effectively prevent short-circuiting, rise in internal resistance, or drop in capacity for a long time. As a result, the electrochemical device 10 can achieve high long-term reliability.

With the electrochemical device 110 according to the comparative example, where the lid 112 and seal ring 113 function as a negative electrode, the lid 112 and seal ring 113 must be formed with a conductive metal material.

On the other hand, the electrochemical device 10 according to this embodiment, where the lid 12 and seal ring 13 do not function as an electrode, any material that can be adopted for forming the lid 12 and seal ring 13 has a high degree of freedom. This means that, with the electrochemical device 10, an inexpensive material can be selected for the lid 12 and seal ring 13, or a material offering high workability can be selected for the lid 12 and seal ring 13 to simplify the manufacturing process, for example. Accordingly, the electrochemical device 10 allows for reduction of manufacturing cost.

With the electrochemical device 110 according to the comparative example, the lid 112 functions as a negative electrode and therefore the negative electrode wiring 115 must be led out to the bottom face of the base material 111 in the Z-axis direction from the lid 112 positioned above in the Z-axis direction. Accordingly, the electrochemical device 110 requires that a long via hole 115a be provided in the Z-axis direction to connect the seal ring 113 and inter-layer wiring 115c.

On the other hand, the wirings 14, 15 can be short with the electrochemical device 10 according to this embodiment, because the two active material electrodes 16, 17 are both located on the bottom face of the concaved pan 11c of the base material 11. This means that the material for forming the wirings 14, 15 can be reduced, while at the same time the manufacturing process can be simplified because the wiring structure of the base material 11 is simple. Accordingly, the manufacturing cost of the electrochemical device 10 can be reduced.

Furthermore with the electrochemical device 10 according to this embodiment, the two active material electrodes 16, 17 are both located on the bottom face of the concaved part 11c of the base material 11 and therefore the device can be made thinner in the Z-axis direction than the electrochemical device 110 according to the comparative example where the two active material electrodes 116, 117 are laminated in the Z-axis direction.

With the electrochemical device 110 according to the comparative example, the electric storage element d has a laminate structure constituted by the active material electrodes 116, 117. Accordingly, the electrochemical device 110 requires that the separator 121 be provided between the active material electrode 116 and active material electrode 117 so as to prevent direct contact between the active material electrode 116 and active material electrode 117.

With the electrochemical device 10 according to this embodiment, on the other hand, the electric storage element d is such that the active material electrodes 16, 17 are positioned away from each other on the same plane (bottom face of the concaved part 11c of the base material 11). This means that, with the electrochemical device 10, the active material electrode 16 does not directly contact the active material electrode 17, and consequently there is no need to provide a separator between the active material electrode 16 and active material electrode 17. Accordingly, the electrochemical device 10 can reduce the number of parts and simplify the manufacturing process. As a result, the manufacturing cost of the electrochemical device 10 can be reduced.

With the electrochemical device 110 according to the comparative example, the constitution of the positive electrode is different from that of the negative electrode. To be specific, with the electrochemical device 110, while the positive electrode wiring 114 is led out from the bottom face of the concaved part 111c of the base material 111, the negative electrode wiring 115 is led out from the lid 112. Accordingly, with the electrochemical device 110 the external electrode terminal 114b of the wiring 114 must be used as a positive electrode and the external electrode terminal 115b of the wiring 115, as a negative electrode. In other words, the external electrode terminals 114b, 115b are not compatible in terms of polarity.

On the other hand, the electrochemical device 10 according to this embodiment is such that the structure on the side of the active material electrode 16 is symmetrical to the structure on the side of the active material electrode 17. With the electrochemical device 10, therefore, either of the external electrode terminal 14b of the wiring 14 and external electrode terminal 15b of the wiring 15 can be used as a positive electrode or negative electrode. In other words, the external electrode terminals 14b, 15b are compatible in terms of polarity. As a result, orientation need not be considered when the electrochemical device 10 is embedded in electronic equipment, etc., which makes it easy to mount the device in electronic equipment, etc.

### Modified Examples

Modified examples of the electrochemical device 10 according to this embodiment are explained below. With each electrochemical device, same components are assigned the same symbols used for the corresponding components and their explanation is omitted as deemed appropriate.

### Modified Example 1

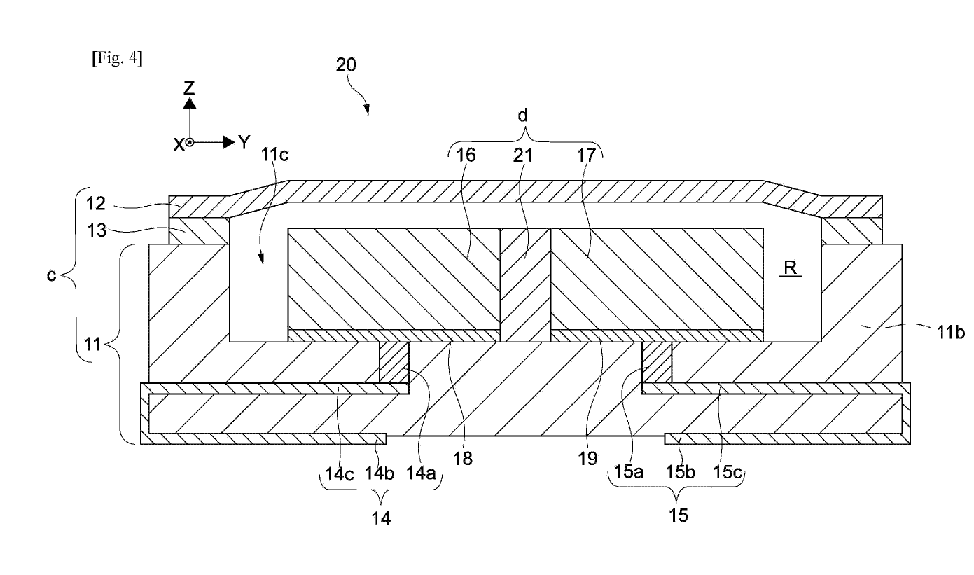

FIG. 4 is a schematic section view of an electrochemical device 20 according to Modified example 1 of this embodiment. The electrochemical device 20 includes a separator 21 sandwiched between an active material electrode 16 and active material electrode 17. In other words, the electric storage element d of the electrochemical device 20 is constituted by the active material electrode 16, active material electrode 17, and separator 21 sandwiched between the active material electrodes 16, 17.

With the electrochemical device 20, where the separator 21 is provided, a channel for electrolytic solution can be ensured, while at the same time short-circuiting that may be otherwise caused by direct contact between the active material electrode 16 and active material electrode 17 can be prevented even when the active material electrode 16 is positioned close to the active material electrode 17. Accordingly, reliability of the electrochemical device 20 can be ensured even when its size is reduced.

### Modified Example 2

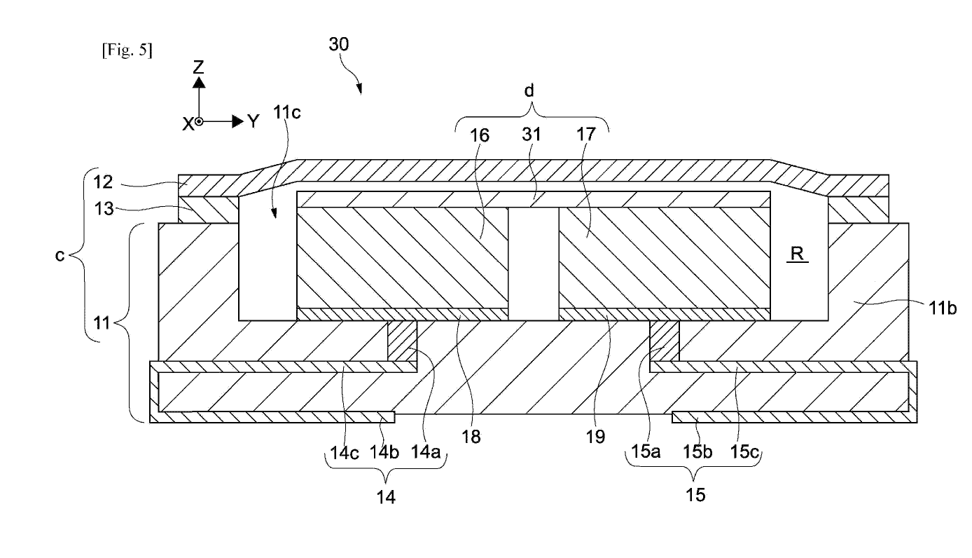

FIG. 5 is a schematic section view of an electrochemical device 30 according to Modified example 2 of this embodiment. The electrochemical device 30 includes a separator 31 cross-linking the top faces, in the Z-axis direction, of the active material electrode 16 and active material electrode 17. In other words, the electric storage element d of the electrochemical device 30 is constituted by the active material electrode 16, active material electrode 17, and separator 31 cross-linking the active material electrodes 16, 17.

With the electrochemical device 30, where the separator 31 is provided, a channel for electrolytic solution can be ensured, while at the same time short-circuiting that may be otherwise caused by direct contact between the active material electrode 16 and active material electrode 17 can be prevented because the active material electrode 16 and active material electrode 17 maintain their relative positions.

### Modified Example 3

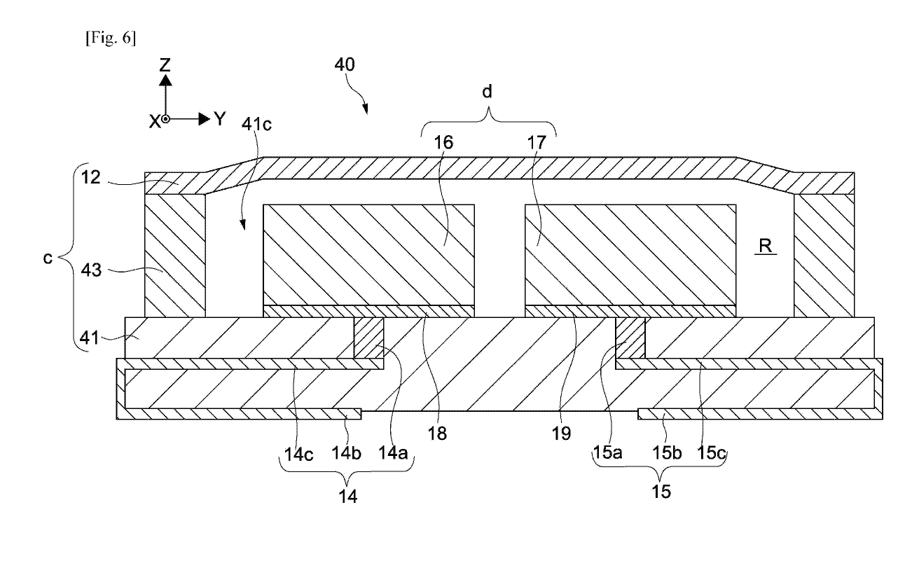

FIG. 6 is a schematic section view of an electrochemical device 40 according to Modified example 3 of this embodiment. The electrochemical device 40 is different from the electrochemical device 10 in terms of the constitution of the container c. To be specific, the electrochemical device 40 uses the same lid 12 as with the electrochemical device 10, but the base materials and seal rings of the two are different.

The container c of the electrochemical device 40 has a plate-shaped base material 41 and a seal ring 43 extending over the wall in the Z-axis direction. The base material 41 is constituted as a plate-shaped member comprising only the bottom wall 11a of the base material 11 with the side wall 11b removed. The seal ring 43 forms a concaved part 41c on the top face of the base material 11 in the Z-axis direction by surrounding the X-axis direction and Y-axis direction of the solution chamber R as if to serve as the side wall 11c of the base material 11 and the seal ring 13.

In other words, the solution chamber R of the electrochemical device 40 is formed by being surrounded by the first face (top face of the base material 41 in the Z-axis direction) to which the active material electrodes 16, 17 are joined, and by the second face (inner face of the seal ring 43 and inner face of the lid 12) away from the active material electrodes 16, 17.

Because of this constitution, the electrochemical device 40 can use any generally used ceramic substrate for the base material 11 because the base material 11 is not shaped like a concavity. Accordingly, the manufacturing cost of the electrochemical device 40 can be reduced.

In addition, it is generally difficult to shape ceramics into a concave shape as designed, and any resulting shape has low dimensional accuracy. With the electrochemical device 40, however, the base material 41 is plate-shaped and the concaved part 41c is formed on top by the seal ring 43. Accordingly, the dimensional accuracy of the container c can be improved by selecting a metal or other easy-to-work material for forming the seal ring 43. As a result, greater design tolerances can be set for positioning the active material electrodes 16, 17 and filling the electrolytic solution in the solution chamber R.

### Modified Example 4

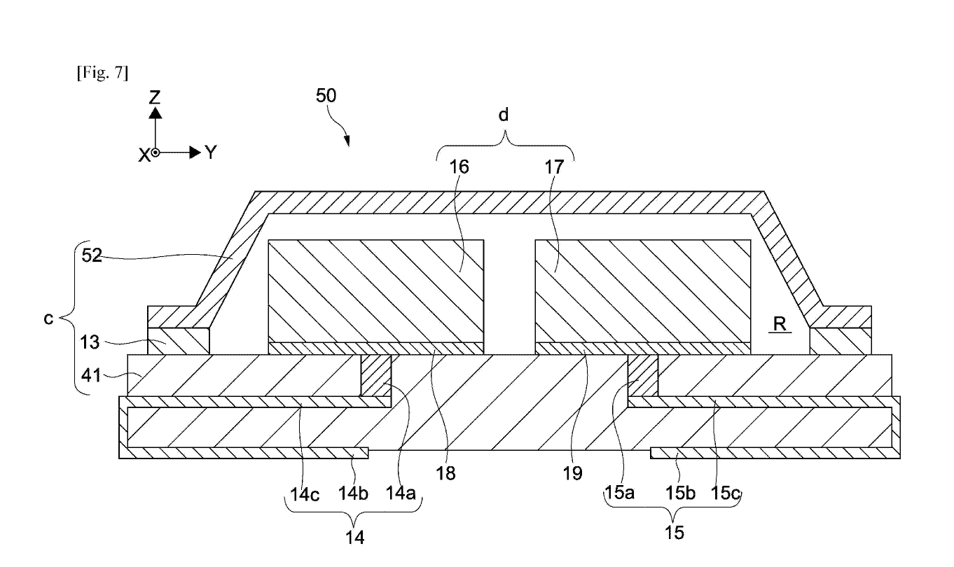

FIG. 7 is a schematic section view of an electrochemical device 50 according to Modified example 4 of this embodiment. The electrochemical device 50 is different from the electrochemical device 10 in terms of the constitution of the container c. To be specific, the electrochemical device 50 uses the same seal ring 13 as with the electrochemical device 10, but the base materials and lids of the two are different.

The container c of the electrochemical device 50 has the same base material 41 as that in Modified example 3, and a lid 52 whose periphery is stepped down deeper compared to the lid 12. The lid 52 surrounds the X-axis direction and Y-axis direction of the solution chamber R and forms a projected part on the top face of the base material 11 in the Z-axis direction. The drawing method, etc., can be adopted for the formation of the lid 52. It should be noted that the lid 52 needs only to have a shape, such as dome shape, that allows for formation of the solution chamber R on the base material 41.

In other words, the solution chamber R of the electrochemical device 50 is formed by being surrounded by the first face (top face of the base material 41 in the Z-axis direction) to which the active material electrodes 16, 17 are joined, and by the second face (inner face of the seal ring 13 and inner face of the lid 52) away from the active material electrodes 16, 17.

According to this constitution, any generally used ceramic substrate can be adopted for the base material 41, as in Modified example 3, and also the dimensional accuracy of the container c can be improved by selecting a metal or other easy-to-work material for forming the lid 52. As a result, greater design tolerances can be set for positioning the active material electrodes 16, 17 and filling the electrolytic solution in the solution chamber R.

### Modified Example 5

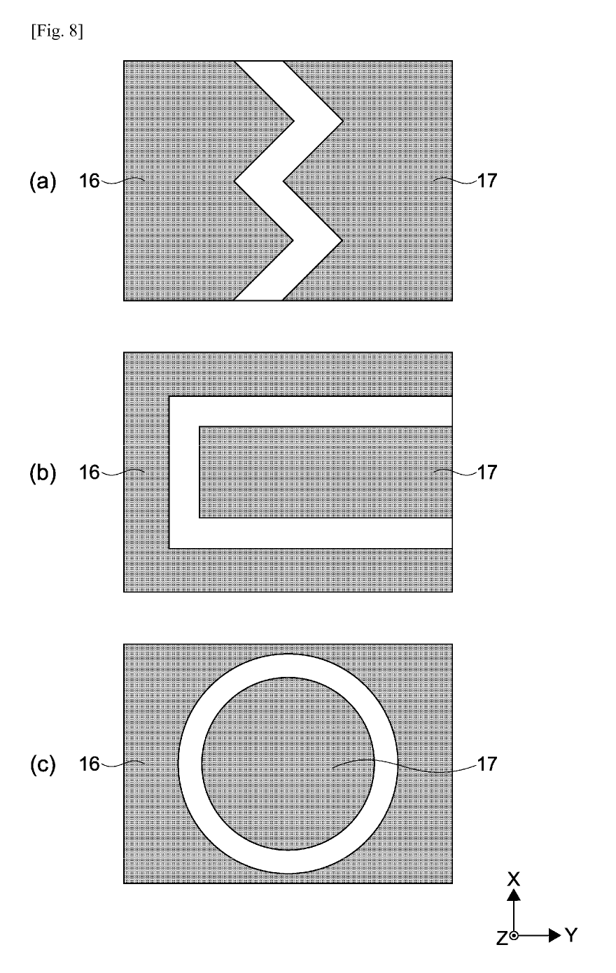

FIG. 8 shows variations of the active material electrodes 16, 17 of the electrochemical device 10 according to this embodiment. In FIG. 8, the components other than the active material electrodes 16, 17 are omitted. The shape of the active material electrodes 16, 17 is not at all limited to rectangle and any shape can be adopted. Also, the active material electrode 16 can have a shape different from that of the active material electrode 17. Either way, the greater the area of the opposing faces of the active material electrode 16 and active material electrode 17, the lower the resistance of the electrochemical device 10 becomes, which is favorable.

(a) in FIG. 8 shows an example where the opposing faces of the active material electrode 16 and active material electrode 17 are zigzag-shaped in order to enlarge the opposing faces. The opposing faces of the active material electrode 16 and active material electrode 17 need not be zigzag-shaped, and the same effects can be obtained by constituting them as wavy or other curved faces.

(b) and (c) in FIG. 8 show examples where the constitution is such that the active material electrode 16 surrounds the active material electrode 17 in order to enlarge the opposing faces of the active material electrode 16 and active material electrode 17. To be specific, as shown in (b) in FIG. 8, a constitution where the three sides of the rectangular active material electrode 17 are surrounded by the U-shaped active material electrode 16 can be adopted. Also, as shown in (c) in FIG. 8, a constitution where the active material electrode 16 from which a circular area has been stamped out surrounds the circular active material electrode 17 can be adopted. Needless to say, the positions of the active material electrodes 16, 17 can be reversed.

### Other Modified Examples

With the electrochemical device 10 according to this embodiment, the conductive adhesion films 18, 19 function as current collector films for the active material electrodes 16, 17, but metal layers can be provided separately from conductive adhesion films 18, 19 as current collector films for the active material electrodes 16, 17.

### Second Embodiment

### Overall Constitution of Electrochemical Device 801

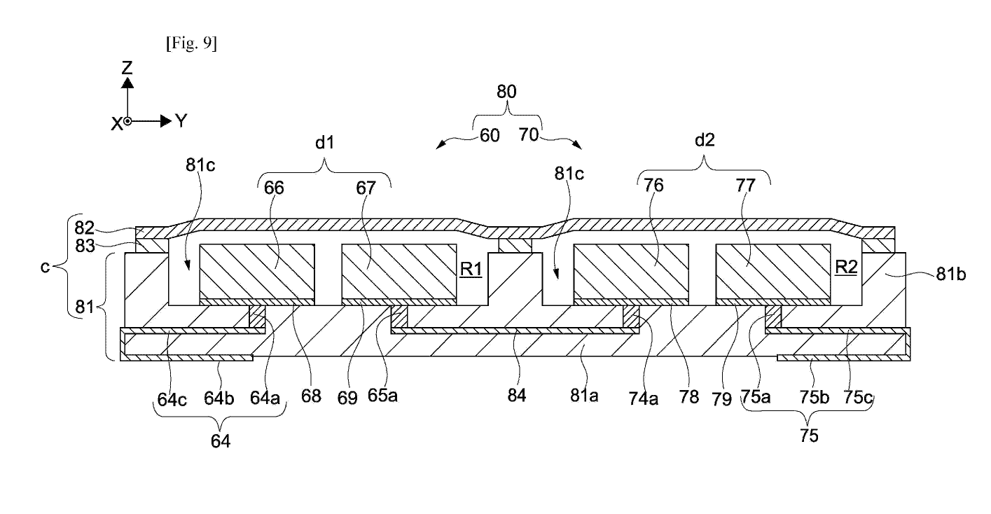

FIG. 9 is a schematic section view of an electrochemical device 80 according to the second embodiment of the present invention. It should be noted that, in this embodiment, the same components as those in the first embodiment are omitted as deemed appropriate.

The electrochemical device 80 can adopt various shapes. As one example, an electrochemical device 80 shaped as a rectangular solid whose width dimension along the X-axis is 2.5 mm, length dimension along the Y-axis is 6.4 mm, and height dimension along the Z-axis is 0.95 mm, is explained in this embodiment.

The constitution of the electrochemical device 80 according to this embodiment is similar to a constitution where two of the electrochemical device 10 according to the first embodiment are positioned side by side in the Y-axis direction, with the two electrochemical devices 10 connected in series. With the electrochemical device 80, this constitution is realized as a single element. The electrochemical device 80 includes two electrochemical units 60, 70, each corresponding to the electrochemical device 10.

The electrochemical device 80 has a container c comprising a base material 81, lid 82, and seal ring 83. The electrochemical device 80 has a single set of base material 81, lid 82, and seal ring 83 for the electrochemical units 60, 70.

The base material 81 has a bottom wall 81a, side wall 81b, and concaved part 81c formed by the bottom wall 81a and side wall 81b. The concaved part 81c is formed at two locations corresponding to the electrochemical units 60, 70. Each concaved part 81c is sealed by the lid 82 via the seal ring 83, and forms a solution chamber R1 for the electrochemical unit 60 or solution chamber R2 for the electrochemical unit 70. The solution chamber R1 and solution chamber R2 are adjoining each other over the side wall 81b of the base material 81.

An electric storage element d1 comprising a pair of active material electrodes 66, 67 is sealed in the solution chamber R1 for the first electrochemical unit 60 together with electrolytic solution. The active material electrodes 66, 67 are joined to the bottom face of the concaved part 81c via conductive adhesion layers 68, 69, respectively. An electric storage element d2 comprising a pair of active material electrodes 76, 77 is sealed in the solution chamber R2 for the second electrochemical unit 70 together with electrolytic solution. The active material electrodes 76, 77 are joined to the bottom face of the concaved part 81c via the conductive adhesion layers 78, 79, respectively.

With the electrochemical device 80, an external electrode terminal 64b is led out from the active material electrode 66 positioned in the first electrochemical unit 60 on the far side from the second electrochemical unit 70, while an external electrode terminal 75b is led out from the active material electrode 77 positioned in the second electrochemical unit 70 on the far side from the first electrochemical unit 60. In addition, the active material electrode 67 of the first electrochemical unit 60 and active material electrode 76 of the second electrochemical unit 70, which are adjoining each other over the side wall 81b of the base material 81, are connected by a connection wiring 84.

According to the above constitution, where the electrochemical units 60, 70 are connected in series, the electrochemical device 80 allows the two electric storage elements d1, d2 to be charged/discharged using the external electrode terminals 64b, 75b.

### Wiring Structure of Base Material 81

The base material 81 has a first wiring 64 connected to the active material electrode 66 and second wiring 75 connected to the active material electrode 77. The wirings 64, 75 have via holes 64a, 75a, external electrode terminals 64b, 75b, and inter-layer wirings 64c, 75c, all embedded in the bottom face of the concaved part 11c.

The via holes 64a, 75a are exposed on the bottom face of the concaved part 81c and adjoining the conductive adhesion layers 68, 79, respectively. This way, the via holes 64a, 75a are connected to the active material electrodes 66, 77 via the conductive adhesion layers 68, 79.

The external electrode terminals 64b, 75b are provided on both ends of the base material 81 in the Y-axis direction, respectively. To be specific, the external electrode terminals 64b, 75b are provided integrally on the outer face of the base material 81 over the section from the bottom wall 81a to the side wall 81b.

The inter-layer wirings 64c, 75c are formed between the multiple layers of ceramic sheets constituting the bottom wall 81a. The inter-layer wirings 64c, 75c connect the via holes 64a, 75a and external electrode terminals 64b, 75b, respectively.

Also, the base material 81 has a via hole 65a connected to the active material electrode 67 and via hole 74a connected to the active material electrode 76. The via holes 65a, 74a are exposed on the bottom face of the concaved part 81c and adjoining the conductive adhesion layers 69, 78, respectively. This way, the via holes 65a, 74a are connected to the active material electrodes 67, 76 via the conductive adhesion layers 69, 78, respectively.

Furthermore, the base material 81 has connection wiring 84 that connects the via hole 65a and via hole 74a. The connection wiring 84 conducts the active material electrode 67 with the active material electrode 76, thereby connecting the first electrochemical unit 60 and second electrochemical unit 70.

### Operations and Effects of Electrochemical Device 801

The electrochemical device 80 according to this embodiment functions as a single electric storage element comprising a positive-electrode active material electrode 66, negative-electrode active material electrode 67, positive-electrode active material electrode 76, and negative-electrode active material electrode 77 connected in series in this order, if charged/discharged using the external electrode terminal 64b as a positive electrode and the external electrode terminal 75b as a negative electrode. Also, the electrochemical device 80 functions as a single electric storage element comprising a negative-electrode active material electrode 66, positive-electrode active material electrode 67, negative-electrode active material electrode 76, and positive-electrode active material electrode 77 connected in series in this order, if charged/discharged using the external electrode terminal 64b as a negative electrode and the external electrode terminal 75b as a positive electrode.

As explained above, the electrochemical device 80 according to this embodiment can be charged/discharged at a voltage twice that of the electrochemical device 10, just as when two of the electrochemical device 10 according to the first embodiment are connected in series.

Also, with the electrochemical device 80, fewer parts are required and the manufacturing cost decreases because the two electrochemical units 60, 70 are held by the single base material 81 and sealed by the single lid 82. In addition, the electrochemical device 80 can be handled in a favorable manner when mounted in electronic equipment, etc., because the two electrochemical units 60, 70 are held by the single base material 81.

The operations and effects of the electrochemical device 80 according to this embodiment are explained below based on comparison against electrochemical devices 280, 380 according to comparative examples.

### Rough Constitutions of Electrochemical Devices 280, 380 According to Comparative Examples

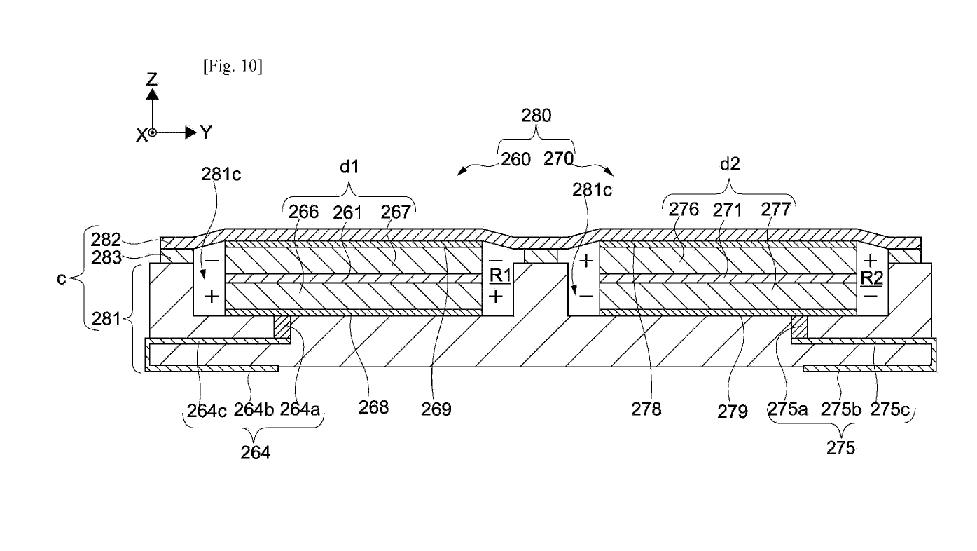

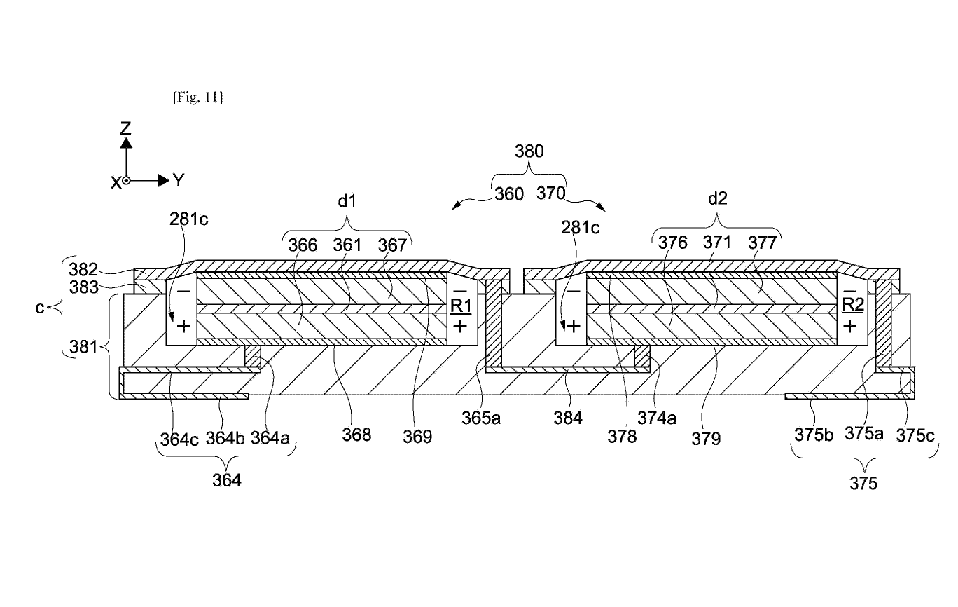

FIG. 10 is a schematic section view of an electrochemical device 280 according to a comparative example of this embodiment, while FIG. 11 is a schematic section view of an electrochemical device 380 according to a comparative example of this embodiment. The constitution of the electrochemical device 280 is similar to a constitution where two of the electrochemical device 110 shown in FIG. 3 are positioned side by side in the Y-axis direction, with the two electrochemical devices 110 connected in series. The electrochemical device 280 includes two electrochemical units 260, 270, each corresponding to the electrochemical device 110, while the electrochemical device 380 includes two electrochemical units 360, 370, each corresponding to the electrochemical device 110.

With the electrochemical device 280 shown in FIG. 10, the electric storage element d1 of the first electrochemical unit 260 is connected to the electric storage element d2 of the second electrochemical unit 270 via a lid 282. This means that, with the electrochemical device 280, an active material electrode 266, active material electrode 267, active material electrode 276, and active material electrode 277 are connected in series in this order, if the two electric storage elements d1, d2 are charged/discharged using the external electrode terminal 264b of a wiring 264 as a positive electrode and an external electrode terminal 275b of a wiring 275 as a negative electrode. Accordingly, while the active material electrode 267 on the lid 282 side becomes the negative electrode with the first electrochemical unit 260, the active material electrode 276 on the lid 282 side becomes the positive electrode with the second electrochemical unit 270.

As described above, with the electrochemical device 280, one of the electrochemical units 260, 270 has the positive electrode on the lid 282 side even when one of the external electrode terminals 264b, 275b of the wirings 264, 275 is used as the positive electrode. This means that, with the electrochemical device 280, the metal material forming the lid 282 and seal ring 283 elutes to the electrolytic solution easily in the electrochemical unit having the positive electrode on the lid 282 side. As a result, the electrochemical device 280 is prone to short-circuiting, rise in internal resistance, and drop in capacity.

The electrochemical device 380 solves this problem with the electrochemical device 280. In the electrochemical device 380, wirings 365a, 384, 374a are provided to connect a lid 382 of the first electrochemical unit 360 to a conductive adhesion film 379 of the second electrochemical unit 370 so that active material electrodes 367, 377 on the lid 382 side become the negative electrodes of the electrochemical units 360, 370.

According to this constitution, the active material electrodes 367, 377 on the lid 382 side become the negative electrodes in the electrochemical device 380. As described above, however, corrosion still occurs due to long-term use, etc., even if the lid 382 is the negative electrode.

### Comparison of this Embodiment and Comparative Examples

As described above, the electrochemical device 280 according to one comparative example is prone to corrosion of the lid 282, while the electrochemical device 380 cannot achieve long-term reliability. With the electrochemical device 80 according to this embodiment, on the other hand, high long-term reliability can be achieved without causing the lid 82 to corrode.

With the electrochemical device 380 according to another comparative example, via holes 364a, 375a for connecting to the lid 282 positioned above in the Z-axis direction must be formed longer. With the electrochemical device 80 according to this embodiment, on the other hand, the active material electrodes 66, 67, 76, 77 are all provided on the bottom face of the concaved part 81c of the base material 81 and thus there is no need to provide long via holes. The manufacturing cost of the electrochemical device 80 can be decreased because the two electrochemical units can be connected by simple wirings below the active material electrodes 66, 67, 76, 77 in the Z-axis direction.

### Modified Examples

While two electrochemical units 60, 70 were connected in the electrochemical device 80 according to this embodiment, the number of electrochemical units to be connected can be determined arbitrarily according to the necessary voltage, etc. Also, while multiple electrochemical units 60, 70 were connected in series in the electrochemical device 80, multiple electrochemical units can be connected in parallel according to the necessary capacity, etc. Furthermore, any desired number of electrochemical units can be connected in series or in parallel in any combination according to the necessary voltage and capacity to constitute an electrochemical device.

In any case, multiple electrochemical units can be connected by simple wirings below all active material electrodes in the Z-axis direction, just like in the electrochemical device 80 according to this embodiment.

Just like in the electrochemical devices 20, 30 shown in FIGS. 4 and 5, respectively, a separator can be provided between the pair of active material electrodes forming the electric storage element d. Also, a plate-shaped base material can be used and multiple solution chambers R can be formed on this base material using seal rings and lids, just like in the electrochemical devices 40, 50 shown in FIGS. 6 and 7, respectively. Furthermore, the shapes of the active material electrodes can be changed in the same manner as the active material electrodes shown in FIG. 8.

The foregoing explained embodiments of the present invention, but it goes without saying that the present invention is not at all limited to the aforementioned embodiments and various changes can be added to the extent that they do not deviate from the key points of the present invention.

In the present disclosure where conditions and/or structures are not specified, a skilled artisan in the art can readily provide such conditions and/or structures, in view of the present disclosure, as a matter of routine experimentation. Also, in the present disclosure including the examples described above, any ranges applied in some embodiments may include or exclude the lower and/or upper endpoints, and any values of variables indicated may refer to precise values or approximate values and include equivalents, and may refer to average, median, representative, majority, etc. in some embodiments. Further, in this disclosure, an article “a” or “an” may refer to a species or a genus including multiple species, and “the invention” or “the present invention” may refer to at least one of the embodiments or aspects explicitly, necessarily, or inherently disclosed herein. In this disclosure, any defined meanings do not necessarily exclude ordinary and customary meanings in some embodiments.

The present application claims priority to Japanese Patent Application No. 2012-238461, filed October 30, the disclosure of which is incorporated herein by reference in its entirety.

It will be understood by those of skill in the art that numerous and various modifications can be made without departing from the spirit of the present invention. Therefore, it should be clearly understood that the forms of the present invention are illustrative only and are not intended to limit the scope of the present invention.

We/I claim:

1. An electrochemical device equipped with:
a solution chamber housing electrolytic solution and having a first face and a second face opposing the first face; and
an electric storage element positioned in the solution chamber and having a first electrode provided on the first face and a second electrode provided on the first face away from the first electrode.

2. An electrochemical device according to claim 1, wherein the second face is away from the electric storage element.

3. An electrochemical device according to claim 1, wherein said electrochemical device is further equipped with a base material having the first face and a lid having the second face.

4. An electrochemical device according to claim 2, wherein said electrochemical device is further equipped with a base material having the first face and a lid having the second face.

5. An electrochemical device according to claim 3, wherein said electrochemical device is further equipped with a seal which is positioned between the base material and lid and which has the second face.

6. An electrochemical device according to claim 4, wherein said electrochemical device is further equipped with a seal which is positioned between the base material and lid and which has the second face.

7. An electrochemical device according to claim 3, wherein said electrochemical device is further equipped with a pair of external electrode terminals exposed on a face opposite the first face of the base material and led out from the first electrode and second electrode, respectively.

8. An electrochemical device according to claim 4, wherein said electrochemical device is further equipped with a pair of external electrode terminals exposed on a face opposite the first face of the base material and led out from the first electrode and second electrode, respectively.

9. An electrochemical device according to claim 5, wherein said electrochemical device is further equipped with a pair of external electrode terminals exposed on a face opposite the first face of the base material and led out from the first electrode and second electrode, respectively.

10. An electrochemical device according to claim 6, wherein said electrochemical device is further equipped with a pair of external electrode terminals exposed on a face opposite the first face of the base material and led out from the first electrode and second electrode, respectively.

11. An electrochemical device according to claim 1, wherein said electrochemical device is further equipped with conductive adhesion layers which are positioned between the first electrode and first face and between the second electrode and first face, respectively, and which function as current collector films.

12. An electrochemical device according to claim 2, wherein said electrochemical device is further equipped with conductive adhesion layers which are positioned between the first electrode and first face and between the second electrode and first face, respectively, and which function as current collector films.

13. An electrochemical device equipped with:
multiple electrochemical units, each comprising: a solution chamber housing electrolytic solution and having a first face and a second face opposing the first face; and an electric storage element positioned in the solution chamber and having a first electrode provided on the first face and a second electrode provided on the first face away from the first electrode; and
connection wirings that connect the multiple electrochemical units.

14. An electrochemical device according to claim 13, wherein said electrochemical device is further equipped with a base material having the first face and which is common to the multiple electrochemical units.

15. An electrochemical device according to claim 13, wherein said electrochemical device is further equipped with a lid having the second face and which is common to the multiple electrochemical units.

16. An electrochemical device according to claim 14, wherein said electrochemical device is further equipped with a lid having the second face and which is common to the multiple electrochemical units.

17. An electrochemical device according to claim 13, wherein all of the electric storage elements are connected in series by the connection wirings.

18. An electrochemical device according to claim 14, wherein all of the electric storage elements are connected in series by the connection wirings.

19. An electrochemical device according to claim 15, wherein all of the electric storage elements are connected in series by the connection wirings.

20. An electrochemical device according to claim 16, wherein all of the electric storage elements are connected in series by the connection wirings.
